(19) United States
(12) Patent Application Publication
(10) Pub. No.: US 2025/0135243 A1
(43) Pub. Date: May 1, 2025

(54) SMART MANIFOLD FOR BREATHABLE AIR SYSTEM

(71) Applicant: Draeger Medical Systems, Inc., Andover, MA (US)

(72) Inventors: Alex M. Petty, Pasadena, TX (US); George Hoang, Pearland, TX (US); Binu O. Joy, Houston, TX (US); Michael W. Doty, Houston, TX (US); Mark T. Mundy, Tomball, TX (US)

(21) Appl. No.: 18/928,296

(22) Filed: Oct. 28, 2024

Related U.S. Application Data
(60) Provisional application No. 63/546,400, filed on Oct. 30, 2023.

(51) Int. Cl. A62B 9/00; A62B 7/02

(52) U.S. Cl. CPC A62B 9/00; A62B 7/02; A62B 9/006

(57) ABSTRACT

A smart manifold for use in monitoring a breathable air supply system is provided. The smart manifold pulls data representative of the performance of the breathable air supply system and pushes the data to a remotely located cloud-based computing resource. The cloud-based computing resource presents the data to an operator, or “bottle watcher”, though a first user portal. This permits the operator to monitor the breathable air supply system from a distance. It also furthermore permits the operator to concurrently monitor multiple breathable air supply systems since the operator is located remotely and the cloud-based computing resource is scalable.

### RELATED APPLICATIONS

Not applicable.

### TECHNICAL FIELD

The present disclosure relates generally to the field of monitoring the performance of a breathable air system.

### BACKGROUND

This section of this document introduces information about and/or from the art that may provide context for or be related to the subject matter described herein and/or claimed below. It provides background information to facilitate a better understanding of the various aspects of the present invention. This is a discussion of “related” art. That such art is related in no way implies that it is also “prior” art. The related art may or may not be prior art. The discussion in this section of this document is to be read in this light, and not as admissions of prior art.

It is quite common for people to consume supplied air through a mask. This practice is typically found in facilities and environments conducive to or fraught with atmospheric air that is hazardous for human consumption. Air may be supplied from, for example, compressed air sources, regulated, and then delivered to the user through a mask secured to the face. This usually occurs in certain workplace environments and, so, such systems tend to be highly regulated.

### SUMMARY

The present disclosure provides a smart manifold for use in monitoring a breathable air supply system. The smart manifold pulls data representative of the performance of the breathable air supply system and pushes the data to a remotely located cloud-based computing resource. The cloud-based computing resource presents the data to an operator, or “bottle watcher”, though a first user portal. This permits the operator to monitor the breathable air supply system from a distance. It also furthermore permits the operator to concurrently monitor multiple breathable air supply systems since the operator is located remotely and the cloud-based computing resource is scalable.

More particularly, in a first embodiment, a smart manifold for use in a breathable air supply system comprises: a plurality of sensors, a communications interface, and a smart manifold controller. The plurality of sensors adapted to sense respective operational parameters of the breathable air supply system. The smart manifold controller is programmed to: pull data representing the respective operational parameters from the plurality of sensors; and push the pulled data to a cloud-based computing resource located remotely from the breathable air supply and the smart manifold through the communications interface.

In a second embodiment, a breathable air supply system comprises: a breathable air supply, a step-down pressure regulator, one or more masks, a smart manifold, and a cloud-based computing resource. The step-down pressure regulator reduces the pressure of breathable air received from the breathable air supply and delivers a reduced-pressure breathable air supply. The one or more masks receive the reduced-pressure breathable air supply for delivery to an individual breathable air user. The smart manifold is adapted to: pull data representing a plurality of operational parameters of the breathable air supply system; and push the pulled data. The cloud-based computing resource receives the pushed data, provides a first user portal displaying the received data remote from the breathable air supply system, receives interactions from an operator, and responds to the received interactions.

In a third embodiment, a method for monitoring a breathable air supply system provides breathable air to one or more masks from a breathable air supply through a step-down pressure regulator. Data representative of a plurality of operational parameters of the breathable air supply system is pulled to a smart manifold. The pulled data is pushed to a cloud-based computing resource. A cloud-based computing resource then displays the received data to an operator through a portal.

The above presents a simplified summary of the invention as claimed below in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

### BRIEF DESCRIPTION OF THE DRAWINGS

In the drawings, like reference numbers generally indicate identical, functionally similar, and/or structurally similar elements.

FIG. 1 conceptually depicts a breathable air supply system in accordance with one or more embodiments.

FIG. 2 is a block diagram of a smart manifold in accordance with one or more embodiments.

FIG. 3A and FIG. 3B are block diagrams of particular embodiments of the smart manifold controller and the communications interface, respectively, first shown in FIG. 2.

FIG. 4 is a block diagram of one or more embodiments of the cloud-based computing resource first shown in FIG. 1.

FIG. 5 illustrates a method practiced in conjunction with the breathable air supply system of FIG. 1 and the smart manifold of FIG. 2 in accordance with one or more embodiments.

FIG. 6 conceptually depicts a breathable air supply system in accordance with one or more embodiments.

FIG. 7 conceptually depicts a breathable air supply system in accordance with one or more embodiments.

FIG. 8 conceptually depicts a breathable air supply system in which an operator may remotely control a part of the breathable air supply through a smart manifold in accordance with one or more embodiments.

While the disclosed subject matter is susceptible to various modifications and alternative forms, the drawings illustrate specific implementations described in detail by way of example. It should be understood, however, that the description herein of specific examples is not intended to limit that which is claimed to the particular forms disclosed, but on the contrary, the intention is to cover all modifications, equivalents, and alternatives falling within the spirit and scope of the appended claims.

### DETAILED DESCRIPTION

One aspect of breathable air supplies is monitoring their performance. For example, it may be desirable to monitor parameters such as the supplied pressure, the time remaining for the supply, the composition of the breathable air, as well as other parameters. However, the operator, sometimes called a “bottle watcher’, typically only has access to data indicating whether the supplied breathable air and the delivered air are at acceptable pressures. Furthermore, the monitoring occurs at the location of the breathable air supply. This requires the operator to be installed onsite and potentially exposed to the hazardous atmospheric air. Still further, it is common to have multiple breathable air supplies at a single site or facility, meaning multiple operators are stationed for the monitoring.

Turning now to the drawings, illustrative examples of the subject matter claimed below are disclosed. In the interest of clarity, not all features of an actual implementation are described for every example in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

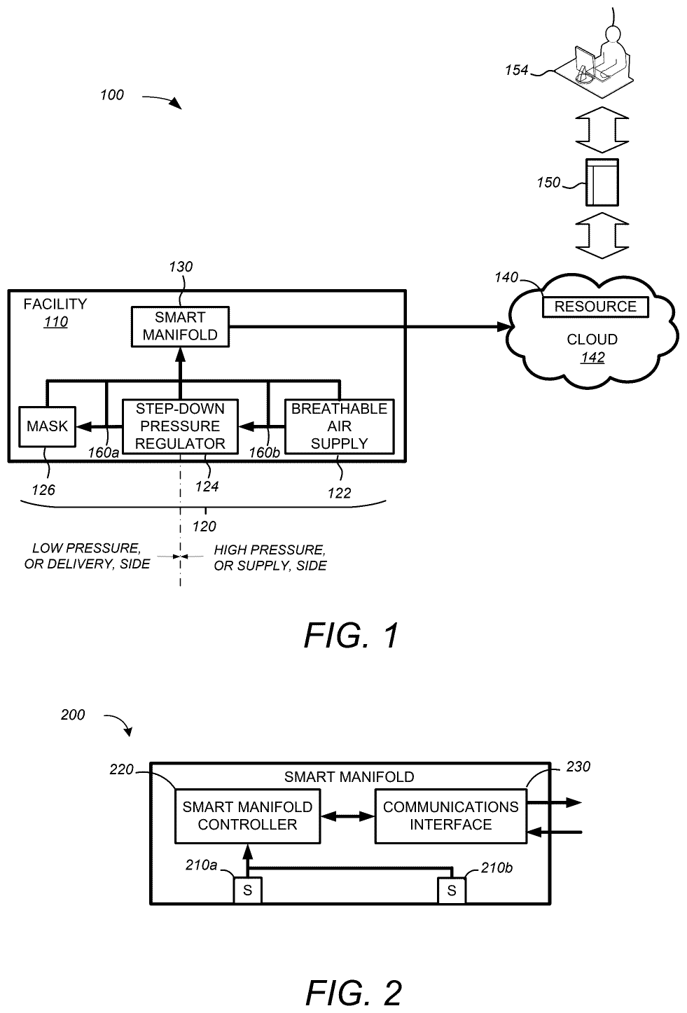

FIG. 1 conceptually depicts a breathable air supply system 100 in accordance with one or more embodiments. The breathable air supply system 100 includes a number of components located at a facility 110. These components include a breathable air delivery system 120 comprised of a breathable air supply 122, a step-down pressure regulator 124, and one or more masks 126. The components at the facility 110 also include a smart manifold 130.

The smart manifold 130 pulls data representing the various operational parameters from the plurality of sensors (not shown in FIG. 1) as will be discussed further below. The smart manifold 130 then pushes the pulled data to a cloud-based computing resource 140 in a cloud 142 located remotely from the breathable air delivery system 120 and the smart manifold 130. The cloud-based computing resource 140 generates and provides a first user portal 150. The first user portal 150 displays the received data remote to an operator 152 at a monitoring station 154. Note that the operator 152 may be more colloquially known as a “bottle watcher”. The first user portal 150 may also, in some embodiments, analyze the data for alarm conditions and, when appropriate, generate and communicate alarms to the operator 152 or others.

In various embodiments, the cloud-based computing resource 140 may process and/or analyze the received data. The analysis may include, for example, detection of alarm conditions, whereupon the cloud-based computing resource 140 may generate an alarm. The alarm may indicate that the supplied pressure from the breathable air supply 122 is too low, or that the composition of the supplied breathable air is out compliance with regulations. The first user portal 150 may receive interactions from the operator 152. For example, such interactions may impart directives responding to an alarm in order to mitigate or cure the alarm condition. The cloud-based computing resource 140 may also respond to the received interactions. Such a response may include, for instance, notifying environmental, health, and safety (“EHS”) personnel about the alarm condition so that they may take corrective action.

Still referring to FIG. 1, as first mentioned above, the breathable air supply 122 provides “breathable air”. In the illustrated embodiments, the breathable air is what is known in the art as “Grade D air” in accordance with regulations of the Occupational Safety and Health Administration (“OSHA”) of the United States federal government. Grade D air, by regulatory definition, includes an oxygen content (v/v) of 19.5-23.5%, a hydrocarbon (condensed) content of 5 milligrams per cubic meter of air or less, a carbon monoxide (CO) content of 10 parts per million (ppm) or less, a carbon dioxide content of 1,000 ppm or less, a dewpoint of 10° F. below ambient, and a lack of noticeable odor.

However, this is an implementation specific detail. The breathable air should comply with applicable legal regulations of the jurisdiction in which the breathable air supply 122 is located. Thus, in alternative embodiments, the breathable air may include a composition other than that which is defined as Grade D air. The claimed subject matter is indifferent to the composition of the breathable air so long as it is safe for human consumption.

The breathable air may be generated onsite for consumption at the site. Conversely, the breathable air may be generated offsite and transported to the site in compressed air cylinders. Techniques for generating breathable air are known to the art and any suitable technique may be used. For example, U.S. Pat. No. 8,840,841 teaches a method and apparatus for generating breathable air, and Grade D air in particular.

The breathable air may be compressed and stored in one or more compressed air cylinders (not shown). The breathable air supply 122 in these embodiments may therefore comprise a plurality of compressed air cylinders in accordance with some conventional practice. Customarily, the compressed air cylinders number, for example, six or twelve. The compressed air cylinders may be located in a stationary rack (not shown) at the facility 110 or mounted on a rack on a “tube trailer” (also not shown) that has been temporarily located at the facility 110.

The breathable air is compressed, stored, and supplied at a pressure too great for human consumption. Accordingly, the breathable air delivery system 120 includes the step-down pressure regulator 124. The step-down pressure regulator 124 may receive breathable air from the breathable air supply 122 at pressures of up to 3,000 psi and step that pressure down to pressures of 80 psi to 125 psi in some embodiments. The step-down pressure regulator 124 may include instrumentation for the operator to monitor or use, such as one or more flow meters (not shown). An operator may, for example, operate one or more valves governing flow rates and/or delivery pressures based on the flow meters.

Some aspects of the nomenclature used herein is determined by the reduction in pressure performed by the step-down pressure regulator 124. Those portions of the breathable air delivery system 120 upstream from the step-down pressure regulator 124 may be referred to as the “high pressure side” or the “supply side” and the breathable air is at a “high pressure” or a “supply pressure”. The breathable air leaving the step-down pressure regulator 124 is at a reduced pressure that may be referred to as a “reduced pressure”, “delivery pressure”, or “low pressure:” Those portions of the breathable air delivery system 120 downstream from the step-down pressure regulator 124 may be referred to as the “delivery side” or the “low pressure side”.

The embodiment illustrated in FIG. 1 delivers breathable air to only one mask 126. Typically, however, there will be more than one mask 126. The number of masks 126 is subject to governmental regulations that limit the number of masks 126 to four (4) or eight (8), but the claimed subject matter is otherwise indifferent to the number of masks 126. Breathable air may be delivered to a plurality of masks 126 through one or more manifolds or “splitters” (not shown).

The smart manifold 130, as mentioned above, pulls data representing the various operational parameters of the air delivery system 120. The operational parameters may include, by way of non-limiting example, one or more of a supply side pressure, a supply side flow rate, a delivery side pressure, a delivery side flow rate, a delivered pressure, a delivery side dew point, a temperature of the supplied air, a temperature of the delivered air, a delivery side relative humidity of the delivered air, condensation, a location, a remaining supply, Grade D compliance, or combinations thereof. The particular operational parameters monitored in any given embodiment will be an implementation specific detail.

In general, it is contemplated by the present disclosure that the smart manifold 130 includes electronic components and/or electronic computing devices operable to receive, transmit, process, store, and/or manage data and information associated performing the functions of the system as described herein, which encompasses any suitable processing device adapted to perform computing tasks consistent with the execution of computer-readable instructions stored in a memory or a computer-readable recording medium.

FIG. 2 is a block diagram of a smart manifold 200 in accordance with one or more embodiments and such as may be used to implement the smart manifold 130 in FIG. 1. The smart manifold 200 includes at least a pair of sensors 210a, 210b, a smart manifold controller 220, and a communications interface 230, all communication over an internal bus 240. In the illustrated embodiment, the sensors 210a, 210b are pressure sensors (or transducers) for sensing the low side or delivery pressure and the high side or supply pressure, respectively. Those in the art having the benefit of this disclosure will appreciate that implementation specific details, such as connectors, have been omitted. Such details are omitted at this stage of the disclosure to further an understanding of, and so as not to obscure, that which is claimed below.

The sensors 210a, 210b are included as a part of the smart manifold 200 to provide the ability to use the smart manifold 200 with pre-existing, commercially available breathable air delivery systems 120 and their components. Rather than having to retrofit or redesign those components to include the sensors, the breathable air delivery system 120 can be modified in the fittings used to connect those components together. For example, the supply and delivery sides of the step-down pressure regulator 124 may be fitted with tees at the points 160a, 160b, shown in FIG. 1. One output of the tees can run to a respective one of the sensors 210a, 210b, shown in FIG. 2 and the other output can run to the mask 126. The breathable air supply 122, the step-down pressure regulator 124, and the mask 126 can therefore all be implemented from commercially available, off the shelf parts in this particular embodiment.

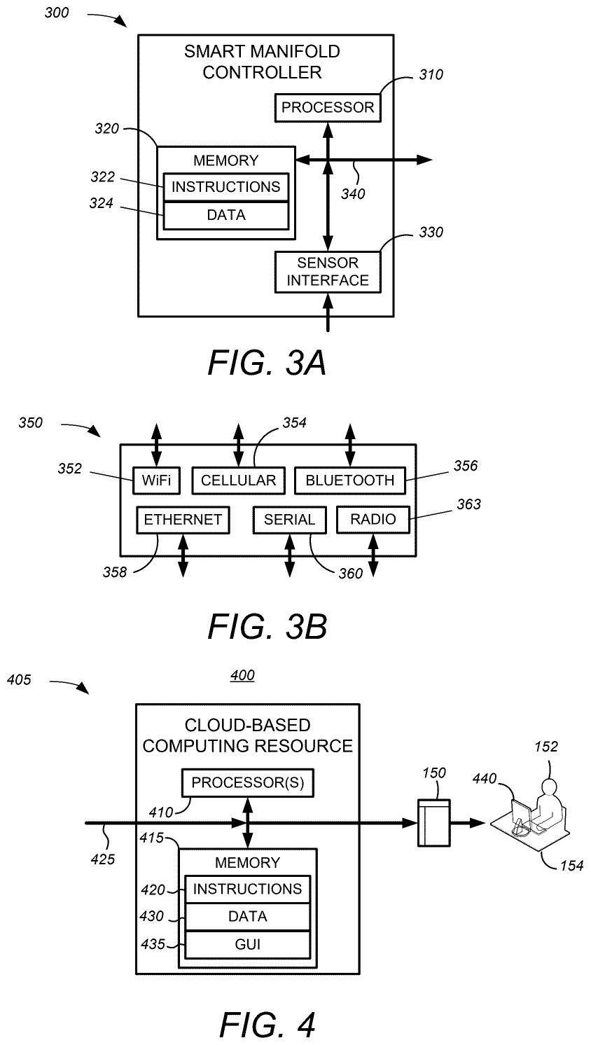

Still referring to FIG. 2, the smart manifold controller 220 is a processor-based resource, one embodiment of which is shown in FIG. 3A. The smart manifold controller 300 comprises at least a processor 310, a memory 320, a sensor interface 330, and a bus 340 over which they communicate. The data is also output from the smart manifold controller 300 to the communications interface 230, shown in FIG. 2, over the bus 340. Note that some embodiments may omit one or both of the memory 320 and the sensor interface 330 depending on the implementation of the smart manifold controller 220.

The term “processor” is used herein in its understood meaning and sense in the art. This term “processor” connotes to those skilled in the art a definite structure including at least an electronic integrated circuit that is in some respect programmed. The processor 310 may be any suitable processor-based resource. Examples include, but are not limited to, a central processing unit (“CPU”), a hardware microprocessor, a multi-core processor, a single core processor, a field programmable gate array (“FPGA”), a controller, a microcontroller, an application specific integrated circuit (“ASIC”), a digital signal processor (“DSP”), or other similar processing device capable of executing any type of instructions, algorithms, or software for controlling the operation and performing the functions of the smart manifold controller 220, shown in FIG. 2. In some embodiments, the processor 310 may comprise a processor chipset including, for example and without limitation, one or more co-processors.

The processor 310 may include a memory (an on-chip memory) or use a separate memory 320 (an off-chip memory), or some combination thereof. The memory may be, for example, a random access memory (“RAM”), a memory buffer, a hard drive, an erasable programmable read only memory (EPROM″), an electrically erasable programmable read only memory (“EEPROM”), a read only memory (“ROM”), a flash memory, a hard disk, or any other non-transitory computer readable medium, or some combination of these types of memories. The memory 320, where off-chip, may be either fixed or installed. The memory 320 may store software or algorithms with executable instructions and the processor 310 may execute a set of instructions 322 of the software or algorithms in association with executing different operations and functions of the smart manifold controller 220, shown in FIG. 2.

The smart manifold controller 220, shown in FIG. 2, may pull and push the data in real time or near real time. The term “near real time” means as close to real time as the computing resources of a given embodiment permit. Real time is the preferred time frame for these operations. In embodiments in which the data is pushed and pulled in near real time, the data 324 may be buffered in the memory 320. In embodiments operating in real time, the buffering may be skipped.

In the illustrated embodiment, the processor 310 is a microcontroller programmed by the instructions 322 residing in the memory 320 operating in real time, such that the data 324 need not be buffered. In embodiments in which the processor 310 is implemented in an ASIC or an FPGA operating in real time, the memory 320 may be omitted altogether as the instructions 322 may be incorporated into the design of the ASIC or programmed into the FPGA. The claimed subject matter admits wide variation in the implementation of the smart manifold controller 220, shown in FIG. 2.

Still referring to FIG. 3A, the sensor interface 330 may be implemented in hardware or combination of hardware and software and is used to connect the smart manifold controller 300 via wired and/or wireless connections to sensors such as the sensors 210a, 210b in FIG. 2. Additionally, or alternatively, one or more sensors (not shown) may be connected to sensor interface 330 via a wireless connection through the communications interface 230. In this case sensor interface 330 may include circuitry for receiving data from and sending data to one or more devices using, for example, a WIFI® connection, a cellular network connection, a Transmission Control Protocol/Internet Protocol (“TCP/IP” connection, a radio frequency connection, and/or a BLUETOOTH® connection, or some combination of these depending on the implementation.

It is also contemplated by the present disclosure that the smart manifold 200 can also be connected to other wired sensors (not shown) or to other wireless sensors (not shown) using the communication interface 230. The communication interface 230 in these embodiments includes circuitry for receiving data from and sending data to one or more devices or sensors using, for example, a wired or wireless connection as further discussed below.

Returning to FIG. 1, the smart manifold 130 pushes the pulled data to a cloud-based computing resource 140 through the communications interface 230, first shown in FIG. 2. The push may be over a private computing system (e.g., a local area network (“LAN”) and/or a wide area network (“WAN”)), a public network (e.g., the Internet), or a combination of the two. The push may also occur over wired connections, wireless connections, or a combination. For example, in some embodiments the push may occur over wireless telephony (e.g., cellular) networks or radio frequency networks. The implementation of the communications interface 230 similarly admits wide variation to accommodate these variations in the push.

FIG. 3B is a block diagram of one particular embodiment of the communications interface 230 in FIG. 2. The communications interface 350 may permit the smart manifold 130, shown in FIG. 1, to directly or indirectly communicate with one or more computing networks and devices, workstations, consoles, computers, monitoring equipment, alert systems, and/or mobile devices (e.g., a mobile phone, tablet, or other hand-held display device). The communications interface 350 may include various network cards, interfaces, communication channels, cloud, antennas, and/or circuitry to permit wired and wireless communications with such computing networks and devices. The communications interface 350 may be used to implement, for example, a BLUETOOTH® connection, a cellular network connection, a Transmission Control Protocol/Internet Protocol (“TCP/IP” connection, and/or a WIFI® connection with such computing networks and devices. Example wireless communication connections implemented using the communication interface 350 include wireless connections that operate in accordance with, but are not limited to, IEEE802.11 protocol, a Radio Frequency For Consumer Electronics (“RF4CE”) protocol, and/or IEEE802.15.4 protocol (e.g., ZigBee® protocol). In essence, any wired or wireless communication protocol may be used.

Accordingly, the communication interface 350 includes three wireless capabilities—WIFI® 352, cellular 354, BLUETOOTH® 356, and radio 363—and two wired capabilities—ETHERNET® 358 and serial interface 360. Example wireless communication connections implemented using the communication interface 350 include wireless connections that operate in accordance with, but are not limited to, IEEE802.11 protocol, a Radio Frequency For Consumer Electronics (“RF4CE”) protocol, and/or IEEE802.15.4 protocol (e.g., ZigBee® protocol). In essence, any wireless communication protocol may be used. So, too, essentially any wired communication protocol may be used. For example, the serial interface 360 may implement RS-232, RS-485, or some other serial interface protocol.

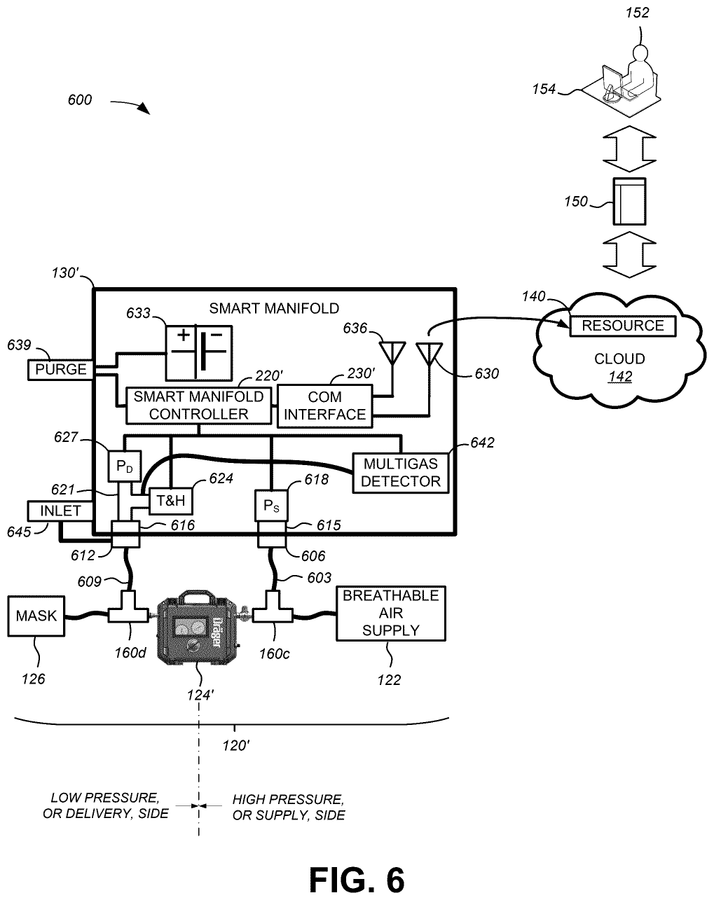

Those in the art having the benefit of this disclosure will appreciate that the communications capabilities shown in FIG. 3B may be unduly redundant for some implementations. Accordingly, some embodiments may include only wireless or wired communications capabilities, or one of each. In these embodiments, the communications interface may be a wired interface or a wireless interface. Some embodiments may include only a single communications capability—for example, only a cellular capability. One such embodiment is discussed further below in connection with FIG. 6. The subject matter claimed below encompasses embodiments including any permutation of the communications capabilities shown in FIG. 3B, as well as others not shown.

FIG. 4 is a block diagram of one or more embodiments of the cloud-based computing resource first shown in FIG. 1. The cloud 400 is a collection of computing resources, including processing resources, memory resources, and communications resources, that may be allocated to different tasks for different users. Typically, the resources that may be allocated is quite scalable depending on the computational needs of the task and/or user. The computational resources of various clouds are now commercially available for lease, and are designed, operated, and managed by the owners of the clouds. Accordingly, the structure, organization, and operation of the cloud 400 itself will not be discussed further herein.

The cloud-based computing resource 405 includes, in this particular embodiment, one or more allocated processor(s) 410 and allocated memory resources 415. As alluded to above, the identity of these resources within the cloud 400 is not material to the practice of the claimed subject matter and is a management/operational issue for the cloud owners. Furthermore, the quantity of the resources may be scaled up or down as needed to accommodate the computational needs of the tasks to be described.

The processor(s) 410 may be any suitable processor-based resource. Examples include, but are not limited to, a central processing unit (“CPU”), a hardware microprocessor, a multi-core processor, a single core processor, a field programmable gate array (“FPGA”), a controller, a microcontroller, an application specific integrated circuit (“ASIC”), a digital signal processor (“DSP”), or other similar processing device capable of executing any type of instructions, algorithms, or software for controlling the operation and performing the functions attributed herein to the cloud-based computation resource 405. In some embodiments, the processor 310 may comprise a processor chipset including, for example and without limitation, one or more co-processors.

The processor(s) 410 may include a memory 415 (an on-chip memory) or use a separate memory 320 (an off-chip memory), or some combination thereof. The memory 415 may be, for example, a random access memory (“RAM”), a memory buffer, a hard drive, an erasable programmable read only memory (EPROM”), an electrically erasable programmable read only memory (“EEPROM”), a read only memory (“ROM”), a flash memory, a hard disk, or any other non-transitory computer readable medium, or some combination of these types of memories. The memory 415, where off-chip, may be either fixed or installed. The memory 415 may store software or algorithms with executable instructions and the microcontroller may execute a set of instructions 420 of the software or algorithms in association with executing different operations and functions cloud-based computing resource 405.

The data pushed by the smart manifold controller 220, shown in FIG. 2, is received over the communications link 425. In the illustrated embodiment, primarily for the sake of discussion, the cloud-based computing resource 405 operates in near real time and so the data is buffered as buffered data 430. However, it is to be understood that embodiments may operate in real time without buffering the data 430 as is discussed above.

The processor(s) 410 execute the instructions 420 to populate a graphical user interface 435 (in this particular embodiment) with the data 430 to create the portal 150. Note that other embodiments may use interfaces other than graphical user interfaces. The portal 150 is displayed to the user 152 on the display device 440 of the monitoring station 154, where the user 152 interacts with the data 430 and monitors the operation of the breathable air supply system 100, shown in FIG. 1.

The monitoring station 154 includes a user interface implemented for allowing interaction and communication between a user 152 and the cloud-based computing resource 405. The display/GUI 112 may include a keyboard (not shown) and/or pointing or tracking device (not shown), as well as the display device 440. The display device 440 may be, by way of non-limiting example, a liquid crystal display (“LCD”), a cathode ray tube (“CRT”) display, a thin film transistor (“TFT”) display, a light-emitting diode (“LED”) display, a high definition (“HD”) display, or other similar display device that may include touch screen capabilities.

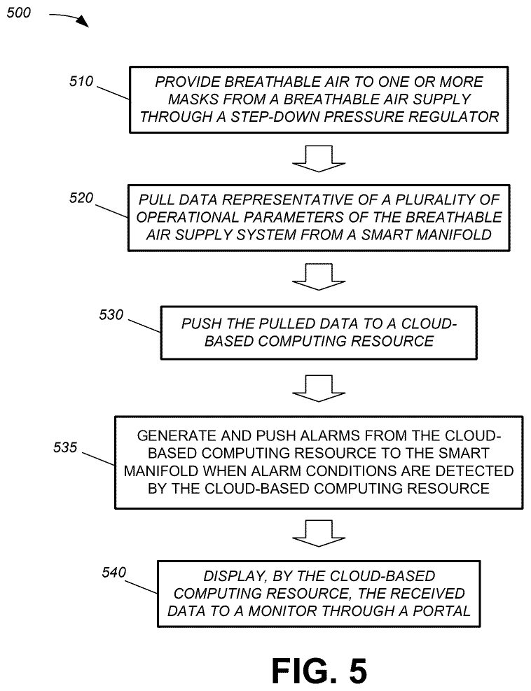

FIG. 5 illustrates a method 500 practiced in conjunction with the breathable air supply system 100 of FIG. 1 and the smart manifold 200 of FIG. 2 in accordance with one or more embodiments. Referring now to FIG. 1 and FIG. 5 concurrently, the method 500 for monitoring a breathable air supply system 100 begins by providing (at 510) breathable air to one or more masks 126 from a breathable air supply 122 through a step-down pressure regulator 124. The method 500 then pulls data (at 520) representative of a plurality of operational parameters of the breathable air supply system 100 to a smart manifold 130. Next, the pulled data is pushed (at 530) to a cloud-based computing resource 140. The cloud-based computing resource 140 is programmed to generate and push alarms (at 535) from the cloud-based computing resource 140 to the smart manifold 120 when the cloud-based computing resource 140 detects an alarm condition. The method 500 then displays (at 540), by the cloud-based computing resource 140, the received data to an operator 152 through a portal 150.

To further an understanding of the claimed subject matter, one particular embodiment will now be discussed in association with FIG. 6. The breathable air supply system 600 includes a breathable air delivery system 120′ including a breathable air supply 122, a step-down pressure regulator 124′, and one or more masks 126. The step-down pressure regulator 124′ is an off the shelf unit commercially available from Draeger, Inc. or other supplier. For example, a Victor Air Regulator MFG PN 0781-0532, and/or a Draeger Air Control Box NA11324, a Draeger 3-Way Manifold NA11325, a Draeger 5-Way Manifold NA11326, a Draeger 8-Way Manifold NA11327.

The breathable air delivery system 120′ includes two tees-a supply side tee 160c and a delivery side tee 160d. The supply side tee 160c is a conventional, commercially available Compressed Gas Association (“CGA”) fitting. A CGA fitting is a part of a standardized system for attaching a compressed gas cylinder to a regulator or transfer line. The delivery side tee 160d is a custom Eaton Hansen (“EH”) fitting that those skilled in the art having the benefit of this disclosure will be able to readily produce.

Throughout the discussion of the breathable air supply system 600 a variety of industry standards and technologies will be mentioned relative to various fittings and parts. The choice of standards in this particular embodiment is largely driven by industry standard, regulation, or practice. The claimed subject matter, however, is not necessarily limited by these factors and any suitable standard or other technology may be used in the implementation of, for example, the various fittings described herein.

The smart manifold 130′ receives a sample of the supplied air via the supply side tee 160c, a line 603, and a CGA connector 606. The delivered air is sampled via the delivery side tee 160d, the line 609, and the EH connector 612. The EH connector 612 is connected to the EH Tee 160d via braided hose using ¼-20 NPT fittings in this particular embodiment. The smart manifold 130′ receives the samples through respective National Pipe Taper (“NPT”) connectors 615, 616. The pressure of the supplied air (“Ps”) is measured from the supply side sample by the pressure sensor 618. The pressure sensor may be implemented in, for example, an Omega PN PX319-5KG5GV, although other sensors may be used in other implementations.

The delivery side sample is split by a tee 621. In the illustrated embodiment, the tee 621 uses CGA-346 fittings to connect to the step-down pressure regulator 124′. The temperature and humidity (“T&H”) of the delivery side sample is sensed by a temperature and humidity sensor 624 from a first portion and the delivery pressure (“PD”) is sensed by a pressure sensor 627 from a second portion. The T&H sensor 624 may be implemented with an Atlas PN EZIOHIM-P-ND and the sensor 627 may be implemented with an Omega PN PX309-5KG5V, although other sensors may be used in other implementations.

The smart monitor controller 220′ pulls the supply side pressure, delivery side pressure, delivery side temperature, and delivery side humidity from the sensors 618, 624, 627. The smart monitor controller 220′ then pushes the pulled data via the communications interface 230′ to the cloud 142. In this particular embodiment, the smart manifold 130′ only communicates using wireless, cellular signals and, more particularly, 4G cellular signals. Thus, the communications interface 230′ only includes a cellular capability and, in this embodiment, includes a cellular transceiver (not separately shown) and is electrically coupled to a 4G antenna 630. Note, however, other embodiments may communicate using other technologies.

In the illustrated embodiment, the smart controller 220′ and the communications interface 230′ are implemented together in a set of off the shelf printed circuit boards commercially available from Yoctopuce Sarl. The implementation centers on a YoctoHub-GSM-4G hub which comes with a 4G LTE-M or NB-IoT networking capability, includes a SubMiniature version A (“SMA”) connector for coupling with the 4G antenna 630. The implementation also includes a Yocto-GPS-V2 for a positioning capability as discussed below; a Yocto-0-10V-Rx and a Yocto-I2C for reading the pressure sensors 618, 627; and a Yocot-RS485-V2 for reading the T&H sensor 624.

The smart manifold 130′ also includes a power source, such as a battery 633. The battery 633 is rechargeable and provides all the power needs of the electronics for the smart manifold 130′. In some embodiments, the battery 633 may be separate from the smart manifold 130′. In still other embodiments, the battery 633 may be replaced by an electrical cord terminating in a plug so that the power may be obtained from the facility's grid-fed electrical power system. Still other embodiments may include redundant power sources not shown in the event of power source failure. If there is a complete power failure, the smart controller 220′ will continues pushing data until the power is gone, e.g., the last battery dies after the grid power fails.

It is contemplated that there may be scenarios in which the communication between the smart manifold 130′ and the cloud 142 fails or is interrupted. In such a situation, if the smart manifold 130′ is configured for Message Queuing Telemetry Transport (“MQTT”), the smart manifold controller 220′ will buffer undelivered messages in the onboard storage (not separately shown) until a message is successfully sent. At that time, all buffered messages will be pushed to the cloud 142. The buffered messages are retained until the receipt of the individual message is received, whereupon they will be deleted.

The smart controller 220′ includes capabilities not previously discussed in connection with other embodiments. One such capability is a positioning capability. More particularly, the smart controller 220′ includes a Global Positioning Satellite (“GPS”) transceiver (not separately shown) as a part of the communications interface 230′ and the smart monitor 130′ includes a GPS antenna 636. Note that other embodiments may employ other positioning technologies where such capability is implemented. The positioning data is pulled by the smart monitor controller 220′ and pushed to the cloud-based computing resource 140 for display to the operator 152 through the first user portal 150.

The positioning capability may be useful for tracking the location of the smart manifold 130′. In large facilities and/or large sites there may be a relatively large number of smart manifolds distributed across the facilities and/or site. Check-in and check-out procedures and inventory procedures may not be followed and smart manifolds may be lost or misplaced. In a large facility, lost or misplaced units may be extremely difficult to find. Accordingly, in this particular embodiment, the operator 152 may access location data through the first user portal 150 to assist in locating lost or misplaced units.

Another capability first disclosed in the embodiment of FIG. 6 is a purging system 639. In the illustrated embodiment, the purging system 639 performs what is known as a Type X purge, although other types of purges may be used in other embodiments. The purging system 639 is primarily for use in a control room in a Class I, Division 1 location containing equipment that can only function safely in an unclassified position. Type X purging systems reduce the hazards from Division 1 to unclassified. Power is immediately cut off when the positive-pressure air system fails. Note that the smart manifold 130′ also includes an inlet 645 used for the purge to have continuous air supply at ˜50 to 150 psi.

The purging system 639 includes a purge controller not separately shown. The purge controller may be implemented using, for example, a Tryclops X Purge Controller XP, although other purge controllers may be used. This particular purge controller reduces inside of enclosure requirements from Division 1 to general purpose. Loss of positive-pressure shuts down the smart manifold controller 220′ and the sensors 618, 624, 627 (and any others) via a power disconnect switch. A green LED indicates that the system is properly being maintained and purged. The purge controller continuously purges to prevent flammable dust or gas from penetrating.

The smart manifold 130′ also includes a multi-gas detector 642 that may be used to perform Grade D air checks to ensure that the breathable air complies with Grade D requirements. A suitable multi-gas detector for this context is the Draeger X-AM® 5800 Multi-Gas Detector. This particular multi-gas detector can measure up to five gases and organic vapors and can transmit data via BLUETOOTH®. The five gases may include carbon monoxide (CO), hydrogen sulfide (H₂S), oxygen (O₂), sulfur dioxide (SO₂), nitrogen oxide (NO₂), nitric oxide (NO), phosphine (PH₃), hydrogen cyanide (HCN), ammonia (NH₃), carbon dioxide (CO₂), and chlorine (Cl₂). The organic vapors may include Organic Vapor (OV), Organic Vapor Acid (OV-A, including, for example, ethylene oxide, acrylonitrile, isobutylene, vinyl acetate, ethanol, acetaldehyde, diethyl ether and acetylene), Odorant, Amine, Phosgene (CG), and Ozone (O₃). The smart monitor controller 220′ pulls the output of the multi-gas detector 642 and pushes it to the cloud-based computing resource 140. The cloud-based computing resource 140 can analyze the data and present the results of the analysis, and graphs of the data in some embodiments, to the operator 152 through the first user portal 150.

The cloud-based computing resource 140 not only receives and displays data, it also analyzes data and, in this embodiment, generates alarms where alarm conditions are detected. The temperature and humidity data are analyzed to ensure they are within breathable air limits. Pressure on the delivery side is analyzed to ensure that the user is receiving proper air levels. Pressure on the supply side is analyzed to estimate how much time is remaining during which breathable air may be delivered at acceptable levels. Visual and/or audible alarms may be issued where appropriate. For example, an alarm may be issued when supply side pressure drops below 500 psi, which may be considered an empty breathable air supply. Other alarms conditions may include supply side pressure dropping below 1,000 psi, delivery side pressure dropping below 80 psi, or temperature dropping below a predetermined threshold. Still other alarm conditions may be detected in other embodiments.

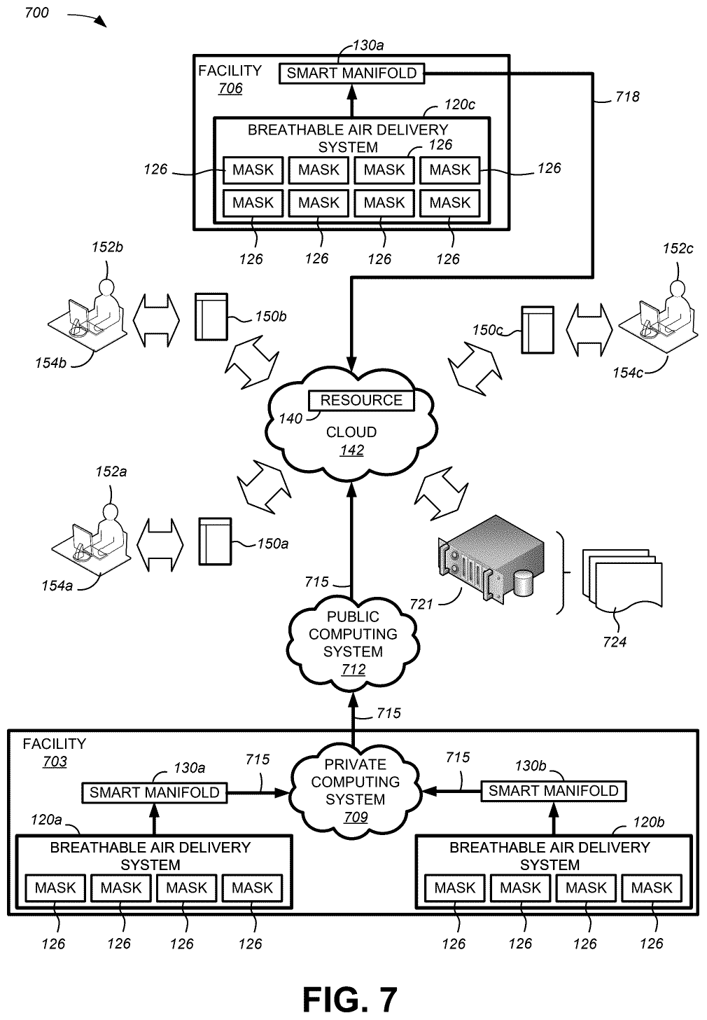

FIG. 7 illustrates yet another embodiment showing variations not discussed above. A breathable air supply system 700 encompasses breathable air delivery at two facilities 703, 706. The geographical proximity of the two facilities 703, 706 relative to one another is immaterial. Similarly, the geographical proximity of the facility hosting the cloud 142 relative to the two facilities 703, 706 is also immaterial. In one particular implementation, the two facilities are owned by two different entities.

The facility 703 includes two breathable air delivery systems 120a, 120b, each communicating with a respective smart manifold 130a, 130b. Note that each breathable air delivery system 120a, 120b includes four (4) masks 126. The smart manifolds 130a, 130b communicate with the cloud-based computing resource 140 through a private computing system 709—for example, a LAN or a WAN—and a public computing system 712—for instance, the Internet. The communications links 715 may be wired, wireless, or some combination thereof as discussed above.

Alternatively, the smart manifolds 130a may communicate with the cloud-based computing resource using a technology such as wireless telephony (e.g., cellular) or radio frequency signals. For example, 900 MHz radios may be used to transmit data packages in some embodiments. An example would be a 900 MHz radio to connect back to a computing device (not separately shown) which can communicate to the rest of the network, including the cloud-based computing resource. These radios in instances where a longer range is needed than BLUETOOTH® or LORAWAN®.

The facility 706 has a single breathable air delivery system 120c, including eight (8) masks 126, and a respective smart manifold 130c. The smart manifold 130a communicates directly with the cloud-based computing resource 140 directly over the communications link 718. The communications link 718 may be wired, wireless, or some combination thereof as discussed above.

In this particular embodiment, the cloud-based computing resource 140 on the cloud 142 segregates and manages the data pushed by the smart manifolds 120a, 120b, 120c on the basis of who owns the facility from which it originates. Accordingly, the operator 152a at the monitoring station 154a may access and monitor the data originating from the facility 703 through a respective first user portal 150a. This is true regardless of whether such data is pushed by the smart manifold 130a or the smart manifold 130b. At the same time, the cloud-based computing resource 140 denies the operator 152a access to any data originating from facility 706. Similarly, the operator 152b at the monitoring station 154b may access and monitor the data originating from the facility 706 through a respective second user portal 150b. At the same time, the cloud-based computing resource 140 denies the operator 152b access to any data originating from facility 703.

Note that even within the same ownership rights, the cloud-based computing resource 140 may segregate the data originating from the facility 703 depending on whether it is pushed by the smart manifold 130a or the smart manifold 130b. The segregated data is also segregated for display in the first user portal 150a. Such segregation permits the operator 152a to monitor the performance of the breathable air delivery systems 120a, 120b individually. This type of individual management is important in the event, for example, an alarm condition exists in one of the breathable air delivery systems 120a, 120b but not the other. Thus, rather than shutting down all breathable air supply across the entire facility 703, only the breathable air delivery system 120a, 120b experiencing the alarm condition need to be shut down while operations at the other may continue.

In some implementations, the cloud-based computing resource 140 may permit access to the data originating in multiple facilities—for instance, both facilities 703, 706—through a third user portal 150c. One circumstance in which this might occur is where the same ownership entity owns multiple facilities. In these implementations, the cloud-based computing resource 140 segregates data not only on the basis of ownership rights and originating breathable air delivery system, but also by facility.

In one particular implementation, however, the operator 152c is an administrator for the entire breathable air supply system 700 regardless of ownership rights to the facilities 703, 706. The smart manifolds 130a, 130b, 130c are owned by a separate ownership entity and leased to the owners of the facilities 703, 706. The administrator 152c therefore has certain rights to access and manage the data generated system-wide regardless of which facility and who owns the facility.

Those in the art having the benefit of this disclosure will appreciate from the discussion immediately above that portals will require credentials for user login and access and that certain permissions will be associated with the credentials. The credentials may be, for example, user identity/password combinations or biometrics and comprise single- or two-step verification, although other kinds of credentials may also be used. The permissions may be stored on a memory resource 721 that is a part of the cloud 142 allocated to the cloud-based computing resource 140. The permissions may be managed by, for instance, the administrator 152c.

Note that the geographical proximity of the monitoring stations 154a, 154b, 154c relative to either the facilities 703, 706 or the cloud 142 is immaterial. One consequence of this fact is that the operators 152a, 152b and the administrator 152c can be located virtually anywhere that communications to the cloud 142 can be established. This also means that the operators 152a, 152b and the administrator 152c need not be located at the facilities 703, 706. This can be significant where the facilities 703, 706 include relatively hazardous working environments. So, in the event of some calamity—whether large or small—the operators 152a, 152b and the administrator 152c can perform their duties without being threatened by the calamity.

In some implementations, the cloud-based computing resource 140 may archive the received data for long term storage. In FIG. 7, the cloud-based computing resource 140 stores the data in a plurality of data structures 724. The data structures 724 may be organized by owner, by facility, by smart manifold, or some combination of these things. It is anticipated that the data will be turned over to the custody of the owners of the facilities 703, 706, who may or may not store them in the cloud 142. The facility owners may store the data structures 724 where convenient for their purposes.

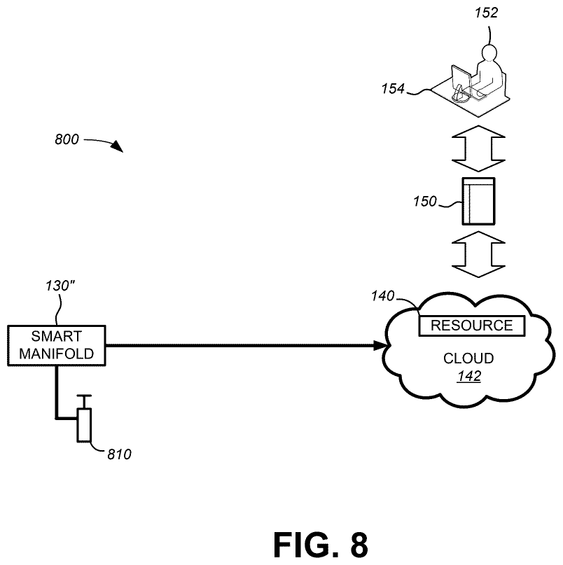

As discussed above, the smart manifolds receive alarms via the smart manifold controller. In an embodiment 800 shown in FIG. 8, the smart manifold 130″, in addition to alarms, receives control signals from the operator 152 through the first portal 150 and cloud-based computing resource 140. For example, some aspects of the air delivery system (not separately shown) may be equipped with remotely operable valves 810. The operator 153, monitoring the operation of the air delivery system via the first portal 150 as described above, may wish to actuate the valve 810 to control some aspect of the operation of the air delivery system. The operator 152 may send a control signal through the first portal 150 to the smart manifold 130″. The smart manifold 130″ may then generate and transmit a control signal to the valve 810. Other applications of this remote operation and control may be discerned by those skilled in the art having the benefit of this disclosure.

Those in the art having the benefit of this disclosure may appreciate still other variations that are within the scope of the claims set forth below. For example, in the illustrated embodiments, each breathable air delivery system interfaces with a respective smart manifold. Thus, in FIG. 1 and FIG. 6, the breathable air delivery system 120 interfaces with the smart manifold 130 and the breathable air delivery systems 120a-120c interfaces with a respective smart manifold 130a-130c. Some embodiments, however, may assign multiple breathable air delivery systems to a single smart manifold. Furthermore, supply air sources could be tied together via a manifold. For example, two 12 packs of pressurized air cylinders may be connected via a tee to the smart manifold to essentially create a 24 pack of pressurized air cylinders. Similarly, two step-down pressure regulators can be tied together, as there is a high pressure outlet on a regulator that can be connected to a second regulator via the second regulator's high pressure inlet. These and other such variations are intended to be within the scope of the claims set forth below.

In a first embodiment, a smart manifold for use in a breathable air supply system comprises a plurality of sensors, a communications interface, and a smart manifold controller. The plurality of sensors is adapted to sense respective operational parameters of the breathable air supply system. The smart manifold controller is programmed to: pull data representing the respective operational parameters from the plurality of sensors; push the pulled data to a cloud-based computing resource located remotely from the breathable air supply and the smart manifold through the communications interface; and receive alarms from the cloud-based computing resource.

In a second embodiment, the smart manifold of the first embodiment further comprises a power supply.

In a third embodiment, the power supply of the smart manifold of the second embodiment comprises a battery.

In a fourth embodiment, the smart manifold of the first embodiment further comprises a purge.

In a fifth embodiment, the smart manifold of the first embodiment further comprises a display.

In a sixth embodiment, in the smart manifold of the first embodiment, the plurality of sensors are adapted to sense one or more of a supply side pressure, a supply side flow rate, a delivery side pressure, a delivery side flow rate, a delivered pressure, a delivery side dew point, a temperature of the supplied air, a temperature of the delivered air, a delivery side relative humidity of the delivered air, condensation, a location, a remaining supply, Grade D compliance, or combinations thereof.

In a seventh embodiment, the communications interface in the smart manifold of the first embodiment is a wireless communications interface.

In an eight embodiment, the wireless communications interface in the smart manifold of the seventh embodiment is a cellular communications interface or a radio frequency communications interface.

In a ninth embodiment, the wireless communications interface in the smart manifold of the seventh embodiment is an interface for a positioning system.

In a tenth embodiment, the smart manifold controller in the smart manifold of the first embodiment is further programmed to received control signals from the cloud-based computing resource.

In an eleventh embodiment, a breathable air supply system comprises a breathable air supply, a step-down pressure regulator, one or more masks, a smart manifold, and a cloud-based computing resource. The step-down pressure regulator reduces the pressure of breathable air received from the breathable air supply and delivers a reduced-pressure breathable air supply. The one or more masks receiving the reduced-pressure breathable air supply for delivery to an individual breathable air user. The smart manifold is adapted to pull data representing a plurality of operational parameters of the breathable air supply system; push the pulled data; and receive alarms The a cloud-based computing resource programmed to: receive the pushed data, generate and push the alarms to the smart manifold when alarm conditions are detected, provide a first user portal displaying the received data at a location remote from the breathable air supply system, receive interactions from an operator, and responding to the received interactions.

In a twelfth embodiment, the breathable air supply system of the eleventh embodiment further comprises a power supply.

In a thirteenth embodiment, the power supply in the breathable air supply system of the twelfth embodiment comprises a battery.

In a fourteenth embodiment, the breathable air supply system of the eleventh embodiment further comprises a purge.

In a fifteenth embodiment, the breathable air supply system of the eleventh embodiment further comprises a display.

In a sixteenth embodiment, in the breathable air supply system of the eleventh embodiment, the plurality of sensors are adapted to sense one or more of a supply side pressure, a supply side flow rate, a delivery side pressure, a delivery side flow rate, a delivered pressure, a delivery side dew point, a temperature of the supplied air, a temperature of the delivered air, a delivery side relative humidity of the delivered air, condensation, a location, a remaining supply, Grade D compliance, or combinations thereof.

In a seventeenth embodiment, the communications interface in the breathable air supply system of the eleventh embodiment is a wireless communications interface.

In an eighteenth embodiment, the wireless communications interface in the breathable air supply system of the seventeenth embodiment is a cellular communications interface or a radio frequency communications interface.

In a nineteenth embodiment, in the breathable air supply system of the eleventh embodiment: the breathable air supply is one of a plurality of breathable air supplies; the smart manifold is one of a plurality of smart manifolds; and the user portal displays the received data of each respective breathable air supply. Each smart manifold pulls data representing a plurality of operational parameters of a respective breathable air supply system; and pushes the pulled data.

In a twentieth embodiment, in the breathable air supply system of the eleventh embodiment, the pulled data is pushed over a private computing system, a public computing system, or a combination thereof.

In a twenty-first embodiment, in the breathable air supply system of the eleventh embodiment, the pulled data is pushed over a wired communications link, a wireless communications link, or a combination thereof.

In a twenty-second embodiment, in the breathable air supply system of the twenty-first embodiment, the pulled data is pushed over a cellular connection.

In a twenty-third embodiment, in the breathable air supply system of the eleventh embodiment, the cloud-based computing resource provides a second user portal.

In a twenty-fourth embodiment, in the breathable air supply system of the twenty-third embodiment, second user portal is an administrative user portal.

In a twenty-fifth embodiment, in the breathable air supply system of the eleventh embodiment, the smart manifold is further adapted to received control signals from the cloud-based computing resource.

In a twenty-sixth embodiment, in the breathable air supply system of the eleventh embodiment: the smart manifold acquires location information for the smart manifold; and pushes the location information to the cloud-based computing resource; and the cloud-based computing resource displays the location information through the first user portal.

In a twenty-seventh embodiment, a method for monitoring a breathable air supply system, comprises: providing breathable air to one or more masks from a breathable air supply through a step-down pressure regulator; pulling data representative of a plurality of operational parameters of the breathable air supply system to a smart manifold; pushing the pulled data to a cloud-based computing resource; generating and pushing alarms from the cloud-based computing resource to the smart manifold when alarm conditions are detected by the cloud-based computing resource; and displaying, by the cloud-based computing resource, the received data to an operator through a first user portal.

In a twenty-eighth embodiment, the method of twenty-seventh embodiment comprises purging the smart manifold.

In the twenty-ninth embodiment, in the method of twenty-seventh embodiment, the data representative of the plurality of operational parameters includes a supply side pressure, a supply side flow rate, a delivery side pressure, a delivery side flow rate, a delivered pressure, a delivery side dew point, a temperature of the supplied air, a temperature of the delivered air, a delivery side relative humidity of the delivered air, condensation, a location, a remaining supply, Grade D compliance, or combinations thereof.

In a thirtieth embodiment, in the method of twenty-seventh embodiment, pushing the pulled data includes wirelessly transmitting the data, transmitting the data over a wired connection, and combinations thereof.

In the thirty-first embodiment, in the method of twenty-seventh embodiment, pushing the pulled data includes pushing the pulled data over a private computing system, a public computing system, or combinations thereof.

In a thirty-second embodiment, in the method of twenty-seventh embodiment, pushing the pulled data includes pushing the pulled data over a cellular connection or a radio frequency connection.

In a thirty-third embodiment, the method of twenty-seventh embodiment further comprises displaying, by the cloud-based computing resource, the received data to a second operator through a second user portal.

In a thirty-fourth embodiment, in the method of the thirty-third embodiment, the second user portal is an administrative user portal.

In a thirty-fifth embodiment, the method of twenty-seventh embodiment further comprises: acquiring, by the smart manifold location information for the smart manifold; pushing the location information to the cloud-based computing resource; and displaying, by the cloud-based computing resource, the location data through the first portal.

In a thirty-sixth embodiment, the method of the twenty-seventh embodiment, further comprises: receiving a control signal from an operator; pushing the control signal from the cloud-based computing resources to the smart manifold; and executing the control signal by the smart manifold.

In a thirty-seventh embodiment, a smart manifold for use in a breathable air supply system is substantially as shown and described.

In a thirty-eighth embodiment, a breathable air supply system is substantially as shown and described.

In a thirty-ninth embodiment, a method for monitoring a breathable air supply system is substantially as shown and described.

As used herein, expressions such as “include” and “may include” which may be used in the present disclosure denote the presence of the disclosed functions, operations, and constituent elements, and do not limit the presence of one or more additional functions, operations, and constituent elements. In the present disclosure, terms such as “include” and/or “have”, may be construed to denote a certain characteristic, number, operation, constituent element, component or a combination thereof, but should not be construed to exclude the existence of or a possibility of the addition of one or more other characteristics, numbers, operations, constituent elements, components or combinations thereof.

As used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

As used herein, to “provide” an item means to have possession of and/or control over the item. This may include, for example, forming (or assembling) some or all of the item from its constituent materials and/or, obtaining possession of and/or control over an already-formed item.

Unless otherwise defined, all terms including technical and/or scientific terms used herein have the same meaning as commonly understood by one of ordinary skill in the art to which the present disclosure pertains. In addition, unless otherwise defined, all terms defined in generally used dictionaries may not be overly interpreted. In the following, details are set forth to provide a more thorough explanation of the embodiments. However, it will be apparent to those skilled in the art that embodiments may be practiced without these specific details. In other instances, well-known structures and devices are shown in block diagram form or in a schematic view rather than in detail in order to avoid obscuring the embodiments. In addition, features of the different embodiments described hereinafter may be combined with each other, unless specifically noted otherwise. For example, variations or modifications described with respect to one of the embodiments may also be applicable to other embodiments unless noted to the contrary.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually exchangeable.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A sensor refers to a component which converts a physical quantity to be measured to an electric signal, for example, a current signal or a voltage signal. The physical quantity may for example comprise electromagnetic radiation (e.g., photons of infrared or visible light), a magnetic field, an electric field, a pressure, a force, a temperature, a current, a voltage, an electrochemical, or a catalytic bead, but is not limited thereto.

Use of the phrases “capable of,” “capable to,” “operable to,” or “configured to” in one or more embodiments, refers to some apparatus, logic, hardware, and/or element designed in such a way to enable the use of the apparatus, logic, hardware, and/or element in a specified manner. Use of the phrase “exceed” in one or more embodiments, indicates that a measured value could be higher than a pre-determined threshold (e.g., an upper threshold), or lower than a pre-determined threshold (e.g., a lower threshold). When a pre-determined threshold range (defined by an upper threshold and a lower threshold) is used, the use of the phrase “exceed” in one or more embodiments could also indicate a measured value is outside the pre-determined threshold range (e.g., higher than the upper threshold or lower than the lower threshold). The subject matter of the present disclosure is provided as examples of apparatus, systems, methods, circuits, and programs for performing the features described in the present disclosure. However, further features or variations are contemplated in addition to the features described above. It is contemplated that the implementation of the components and functions of the present disclosure can be done with any newly arising technology that may replace any of the above-implemented technologies.

The detailed description is made with reference to the accompanying drawings and is provided to assist in a comprehensive understanding of various example embodiments of the present disclosure. Changes may be made in the function and arrangement of elements discussed without departing from the spirit and scope of the disclosure. Various embodiments may omit, substitute, or add various procedures or components as appropriate. For instance, features described with respect to certain embodiments may be combined in other embodiments. In addition, descriptions of well-known functions and constructions may be omitted for clarity and conciseness. Accordingly, those of ordinary skill in the art will recognize that various changes and modifications of the examples described herein can be made without departing from the spirit and scope of the present disclosure.

Various modifications to the disclosure will therefore be readily apparent to those skilled in the art, and the generic principles defined herein may be applied to other variations without departing from the spirit or scope of the present disclosure. Throughout the present disclosure the terms “example,” “examples,” or “exemplary” indicate examples or instances and do not imply or require any preference for the noted examples. Thus, the present disclosure is not to be limited to the examples and designs described herein but is to be accorded the widest scope consistent with the principles and novel features disclosed.

1. A smart manifold for use in a breathable air supply system, the smart manifold comprising:
a plurality of sensors adapted to sense respective operational parameters of the breathable air supply system;
a communications interface; and
a smart manifold controller programmed to:
pull data representing the respective operational parameters from the plurality of sensors;
push the pulled data to a cloud-based computing resource located remotely from the breathable air supply and the smart manifold through the communications interface; and
receive alarms from the cloud-based computing resource.

2-5. (canceled)

6. The smart manifold of claim 1, wherein the plurality of sensors are adapted to sense one or more of a supply side pressure, a supply side flow rate, a delivery side pressure, a delivery side flow rate, a delivered pressure, a delivery side dew point, a temperature of the supplied air, a temperature of the delivered air, a delivery side relative humidity of the delivered air, condensation, a location, a remaining supply, Grade D compliance, or combinations thereof.

7. The smart manifold of claim 1, wherein the communications interface is a wireless communications interface.

8. The smart manifold of claim 7, wherein the wireless communications interface is a cellular communications interface or a radio frequency communications interface.

9. The smart manifold of claim 7, wherein the communications interface includes an interface for a positioning system.

10. The smart manifold of claim 1, wherein the smart manifold controller is further programmed to received control signals from the cloud-based computing resource.

11. A breathable air supply system, comprising:
a breathable air supply;
a step-down pressure regulator reducing the pressure of breathable air received from the breathable air supply and delivering a reduced-pressure breathable air supply;
one or more masks receiving the reduced-pressure breathable air supply for delivery to an individual breathable air user; and
a smart manifold, adapted to:
pull data representing a plurality of operational parameters of the breathable air supply system;
push the pulled data; and
receive alarms; and
a cloud-based computing resource programmed to:
receive the pushed data,
generate and push the alarms to the smart manifold when alarm conditions are detected,
provide a first user portal displaying the received data at a location remote from the breathable air supply system,
receive interactions from an operator, and
responding to the received interactions.

12-18. (canceled)

19. The breathable air supply system of claim 11, wherein:
the breathable air supply is one of a plurality of breathable air supplies; and
the smart manifold is one of a plurality of smart manifolds, each smart manifold:
pulling data representing a plurality of operational parameters of a respective breathable air supply system; and
pushing the pulled data; and
the user portal displays the received data of each respective breathable air supply.

20. The breathable air supply system of claim 11, wherein the pulled data is subsequently pushed over a private computing system, a public computing system, or a combination thereof.

21. The breathable air supply system of claim 11, wherein the pulled data is subsequently pushed over a wired communications link, a wireless communications link, or a combination thereof.

22. (canceled)

23. The breathable air supply system of claim 11, wherein the cloud-based computing resource provides a second user portal.

24. The breathable air supply system of claim 23, wherein the second user portal is an administrative user portal.

25. The breathable air supply system of claim 11, wherein the smart manifold is further adapted to receive control signals from the cloud-based computing resource.

26. The breathable air supply system of claim 11, wherein:
the smart manifold:
acquires location information for the smart manifold; and
pushes the location information to the cloud-based computing resource; and
the cloud-based computing resource displays the location information through the first user portal.

27. A method for monitoring a breathable air supply system, comprising:
providing breathable air to one or more masks from a breathable air supply through a step-down pressure regulator;
pulling data representative of a plurality of operational parameters of the breathable air supply system to a smart manifold;
pushing the pulled data to a cloud-based computing resource;
generating and pushing alarms from the cloud-based computing resource to the smart manifold when alarm conditions are detected by the cloud-based computing resource; and
displaying, by the cloud-based computing resource, the received data to an operator through a first user portal.

28-31. (canceled)

32. The method of claim 27, wherein pushing the pulled data includes pushing the pulled data over a cellular connection or a radio frequency connection.

33. The method of claim 27, further comprising displaying, by the cloud-based computing resource, the received data to a second operator through a second user portal.

34. The method of claim 33, wherein the second user portal is an administrative user portal.

35. The method of claim 27, further comprising:
acquiring, by the smart manifold location information for the smart manifold;
pushing the location information to the cloud-based computing resource; and
displaying, by the cloud-based computing resource, the location data through the first portal.

36. The method of claim 27, further comprising:
receiving a control signal from an operator;
pushing the control signal from the cloud-based computing resources to the smart manifold; and
executing the control signal by the smart manifold.

37-39. (canceled)
